(19) United States
(12) Patent Application Publication
(10) Pub. No.: US 2008/0231630 A1
(43) Pub. Date: Sep. 25, 2008

(54) Web Enabled Three-Dimensional Visualization

(76) Inventors: Victor Shenkar, Ramat-Gan (IL); Alexander Harari, Santa Monica, CA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 11/996,093

(22) PCT Filed: Jul. 20, 2006
(86) PCT No.: PCT/US06/28420

§ 371 Date: Jan. 18, 2008

Related U.S. Application Data
(60) Provisional application No. 60/700,744, filed on Jul. 20, 2005.

(51) Int. Cl. G06T 15/00

(52) U.S. Cl. 345/419

(57) ABSTRACT

A method for presenting a perspective view of a real urban environment, augmented with associated geo-coded content, and presented on a display of a terminal device. The method comprises the steps of: connecting the terminal device to a server via a network; communicating user identification, user present-position information and at least one user command, from the terminal device to the server; processing a high-fidelity, large-scale, three-dimensional (3D) model of an urban environment, and associated geo-coded content by the server; communicating the 3D model and associated geo-coded content from said server to said terminal device, and processing said data layers and said associated geo-coded content, in the terminal device to form a perspective view of the real urban environment augmented with the associated geo-coded content. The 3D model comprises a data layer of 3D building models; a data layer of terrain skin model; and a data layer of 3D street-level-culture models. The processed data layers and the associated geo-coded content correspond to the user present-position, the user identification information, and the user command.

### RELATIONSHIP TO EXISTING APPLICATIONS

The present application claims priority from a provisional patent application 60/700,744 filed Jul. 20, 2005, the contents of which are hereby incorporated by reference.

### FIELD AND BACKGROUND OF THE INVENTION

The present invention relates to a system and a method enabling large-scale, high-fidelity, three-dimensional visualization, and, more particularly, but not exclusively to three-dimensional visualization of urban environments.

With the proliferation of the Internet, online views of the real world became available to everybody. From static, graphic, two-dimensional maps to live video from web cams, a user can receive many kinds of information on practically any place in the world. Obviously, urban environments are of a great interest to a large number of users. However, visualization of urban environments is complex and challenging. There exist three-dimensional models of urban environment that are also available online. These models enable a user to navigate through an urban environment and determine the preferred viewing angle. However, such three-dimensional urban models are very rough and therefore cannot provide the user the experience of roving through “true” urban places.

There is thus a widely recognized need for, and it would be highly advantageous to have, a large-scale, high-fidelity, three-dimensional visualization system and method devoid of the above limitations.

### SUMMARY OF THE INVENTION

According to one aspect of the present invention there is provided a method for presenting perspective view of a real urban environment, the perspective view augmented with associated geo-coded content, the perspective view presented on a display of a terminal device, the method containing:

connecting the terminal device to a server via a network;

communicating user identification, user present-position information and at least one user command, from the terminal device to the server;

processing a high-fidelity, large-scale, three-dimensional (3D) model of an urban environment, and associated geo-coded content by the server, the 3D model containing data layers as follows:
a plurality of 3D building models;
a terrain skin model; and
at least one 3D street-level-culture model;

communicating the 3D model and associated geo-coded content from the server to the terminal device, and

processing the data layers and the associated geo-coded content, in the terminal device to form a perspective view of the real urban environment augmented with the associated geo-coded content,

Wherein at least one of the data layers and the associated geo-coded content correspond to at least one the user present-position, the user identification information, and the user command.

According to another aspect of the present invention there is provided the method for presenting perspective view of a real urban environment, wherein at least one of the data layers additionally contains at least one of:

a 3D avatar representing at least one of a human, an animal and a vehicle; and a visual effect.

According to yet another aspect of the present invention there is provided the method for presenting perspective view of a real urban environment, wherein the terrain skin model contains a plurality of 3D-models representing at least one of: unpaved surfaces, roads, ramps, sidewalks, passage ways, stairs, piazzas, traffic separation islands.

According to still another aspect of the present invention there is provided the method for presenting perspective view of a real urban environment, wherein the 3D street-level-culture model contains a at least one 3D-model representing at least one item of a list containing: a traffic light, a traffic sign, an illumination pole, a bus stop, a street bench, a fence, a mailbox, a newspaper box, a trash can, a fire hydrant, and a vegetation item.

Further according to another aspect of the present invention there is provided the method for presenting perspective view of a real urban environment, wherein the geo-coded content contains information organized and formatted as at least one Web page.

Still further according to another aspect of the present invention there is provided the method for presenting perspective view of a real urban environment, wherein the information organized and formatted as at least one Web page contains at least one of: text, image, audio, and video.

Even further according to another aspect of the present invention there is provided the method for presenting perspective view of a real urban environment, wherein the visual effect contain a plurality of static visual effects and dynamic visual effects.

Additionally according to another aspect of the present invention there is provided the method for presenting perspective view of a real urban environment, wherein the visual effects contain a plurality of visual effects representing at least one of: illumination, weather conditions and explosions.

Additionally according to yet another aspect of the present invention there is provided the method for presenting perspective view of a real urban environment, wherein the avatars contain a plurality of 3D static avatars and 3D moving avatars.

According to still another aspect of the present invention there is provided the method for presenting perspective view of a real urban environment, additionally containing: rendering perspective views of a real urban environment and augmenting them with associated geo-coded content to form an image on a display of a terminal device.

According to yet another aspect of the present invention there is provided the method for presenting perspective view of a real urban environment, wherein the rendering additionally contains at least one of:

rendering the perspective view by the terminal device;

rendering the perspective view by the server and communicating the rendered perspective view to the terminal device; and

rendering some of the perspective views by the server, communicating them to the terminal device, and rendering other the perspective views by the terminal device.

According to still another aspect of the present invention there is provided the method for presenting perspective view of a real urban environment, wherein the rendering additionally contains at least one of:

rendering the perspective views by the server when at least a part of the 3D model and the associated geo-coded content has not been received by the terminal device;

rendering the perspective views by the server when the terminal device does not have the image rendering capabilities; and

rendering the perspective views by the terminal device if the information pertinent to the 3D model and associated geo-coded content have been received by the terminal device and the terminal device has the image rendering capabilities.

Also according to another aspect of the present invention there is provided the method for presenting perspective views of a real urban environment, wherein the rendering of the perspective view is executed in real-time.

Also according to yet another aspect of the present invention there is provided the method for presenting perspective views of a real urban environment, wherein the rendering of the perspective view corresponds to at least one of:

a point-of-view controlled by a user of the terminal device; and

a line-of-sight controlled by a user of the terminal device.

Also according to still another aspect of the present invention there is provided the method for presenting perspective views of a real urban environment, wherein at least one of the point-of-view and the line-of-sight being constrained by a predefined rule.

Further according to another aspect of the present invention there is provided the method for presenting perspective views of a real urban environment, wherein the rule contains at least one of:

avoiding collisions with the building model, terrain skin model and street-level culture model (hovering mode); and

representing a user moving in at least one of:
a street-level walk (walking mode);
a road-bound drive (driving mode);
a straight-and-level flight (flying mode); and
an externally restricted buffer zones (compete-through mode).

Further according to still another aspect of the present invention there is provided the method for presenting perspective views of a real urban environment, wherein the rendering additionally contains at least one of:

controlling at least one of the point-of-view and the line-of-sight by the server (“guided tour”); and

controlling at least one of the point-of-view and the line-of-sight by a user of another terminal device (“buddy mode” navigation).

Still further according to another aspect of the present invention there is provided the method for presenting perspective views of a real urban environment, wherein the perspective view of the real urban environment additionally contains:

enabling a user of the terminal devices to perform at least one of:
search for a specific location within the 3D-model;
search for a specific geo-coded content;
measure at least one of a distance, a surface area, and a volume within the 3D-model; and
interact with a user of another the terminal devices.

According to another aspect of the present invention there is provided a method for hosting an application program within a terminal device, the method containing:

connecting the terminal device to a server via a network;

communicating user identification, user present-position information and the user command, from the terminal device to the server;

communicating a high-fidelity, large-scale, three-dimensional (3D) model of an urban environment, and associated geo-coded content, from the server to the terminal device, the 3D model containing data layers as follows:
a plurality of 3D building models;
a terrain skin model; and
a plurality of 3D street-level-culture models; and

processing the data layers and the associated geo-coded content to form a perspective view of the real urban environment augmented with associated geo-coded content;

Wherein at least one of the perspective views corresponds to at least one of: the user present-position, the user identification information, and the user command, and

Wherein at least one of the perspective views augmented with associated geo-coded content is determined by the hosted application program.

According to still another aspect of the present invention there is provided a display terminal operative to provide perspective views of a real urban environment augmented with associated geo-coded content on a the display terminal containing:

a communication unit connecting the terminal device to a server via a network, the communication unit operative to:

send to the server at least one of: user identification, user present-position information and at least one user command; and

receive from the server a high-fidelity, large-scale, three-dimensional (3D) model of an urban environment, and associated geo-coded content, the 3D model containing data layers as follows:
a plurality if 3D building models;
a terrain skin model; and
a plurality of 3D street-level-culture models; and
a processing unit operative to process the data layers and the associated geo-coded content, as to form perspective views of the real urban environment augmented with associated geo-coded content on a display of the display terminal;

Wherein the perspective view corresponds to at least one of: the user present-position, the user identification information, and the user command.

According to yet another aspect of the present invention there is provided the display terminal operative to provide perspective views of a real urban environment augmented with associated geo-coded content on a the display terminal, wherein the network is one of: personal area network (PAN), local area network (LAN), metropolitan area network (MAN), wide area network (WAN), wired data transmission, wireless data transmission, and combinations thereof.

Also according to another aspect of the present invention there is provided the display terminal operative to provide perspective views of a real urban environment augmented with associated geo-coded content on a the display terminal, additionally operative to host an application program and wherein the combined perspective view is at least partially determined by the hosted application program.

Also according to still another aspect of the present invention there is provided a network server operative to communicate perspective views of a real urban environment augmented with associated geo-coded content to a display terminal, the network server containing:

a communication unit connecting the server to at least one terminal device via a network, the communication unit operative to:
receive from the terminal device user identification, user present-position information and at least one user command; and
send to the terminal device a high-fidelity, large-scale, three-dimensional (3D) model of an urban environment, and associated geo-coded content, the 3D model containing data layers as follows:
   a plurality if 3D building models;
   a terrain skin model; and
   a plurality of 3D street-level-culture models; and

a processing unit operative to process the data layers and the associated geo-coded content to form a perspective view of the real urban environment augmented with associated geo-coded content;

Wherein the perspective view corresponds to at least one of: the user present-position, the user identification information, and the user command.

Additionally according to another aspect of the present invention there is provided the network server operative to communicate perspective views of a real urban environment augmented with associated geo-coded content to a display terminal, wherein the network is one of: personal area network (PAN), local area network (LAN), metropolitan area network (MAN), wide area network (WAN), wired data transmission, wireless data transmission, and combinations thereof.

Further according to another aspect of the present invention there is provided the network server operative to communicate perspective views of a real urban environment augmented with associated geo-coded content to a display terminal, additionally operative to process the data layers and the associated geo-coded content, as to form perspective views of the real urban environment augmented with associated geo-coded content that correspond to at least one the user present-position with the user identification information and at least one user command to be sent to the display terminal.

Still further according to another aspect of the present invention there is provided the network server operative to communicate perspective views of a real urban environment augmented with associated geo-coded content to a display terminal, additionally containing a memory unit operative to host an application program, and wherein the processing unit is operative to form at least one of the perspective views according to instructions provided by the application programs.

Even further according to another aspect of the present invention there is provided a computer program product, stored on one or more computer-readable media, containing instructions operative to cause a programmable processor of a network device to:

connect the terminal device to a server via a network;

communicate user identification, user present-position information and at least one user command, from the terminal device to the server;

communicate a high-fidelity, large-scale, three-dimensional (3D) model of an urban environment, and associated geo-coded content, from the server to the terminal device, the 3D model containing of data layers as follows:
a plurality if 3D building models;
a terrain skin model; and
a plurality of 3D street-level-culture models; and

process the data layers and the associated geo-coded content to form a perspective view of the real urban environment augmented with associated geo-coded content;

Wherein at least one of the perspective views corresponds to at least one of: the user present-position, the user identification information, and the user command.

Also according to another aspect of the present invention there is provided the computer program product, wherein the network is one of: personal area network CAN), local area network (LAN), metropolitan area network (MAN), wide area network (WAN), wired data transmission, wireless data transmission, and combinations thereof.

Also according to yet another aspect of the present invention there is provided the computer program product, additionally operative to interface to an application program, and wherein the application program is operative to determine at least partly the plurality of 3D building models, the terrain skin model, the at least one 3D street-level-culture model, and the associated geo-coded content, according to at least one of the user identification, user present-position information and at least one user command.

Also according to yet another aspect of the present invention there is provided the computer program product, wherein the perspective views augmented with associated geo-coded content are determined by the hosted application program.

Additionally according to another aspect of the present invention there is provided a computer program product, stored on one or more computer-readable media, containing instructions operative to cause a programmable processor of a network server to:

receive user identification, user present-position information and at least one user command from at least one network terminal via a network;

send to the network terminal a high-fidelity, large-scale, three-dimensional (3D) model of an urban environment, and associated geo-coded content, the 3D model containing of data layers as follows:

a plurality if 3D building models;

a terrain skin model; and a plurality of 3D street-level-culture models; and

Wherein the data layers and the associated geo-coded content pertain to at least one of the user identification, the user present-position information and the user command.

Further according to another aspect of the present invention there is provided the computer program product for a network server, wherein the network is one of: personal area network (PAN), local area network (LAN), metropolitan area network (MAN), wide area network (WAN), wired data transmission, wireless data transmission, and combinations thereof.

Still further according to another aspect of the present invention there is provided the computer program product for a network server, additionally operative to combine the plurality of 3D building models, the terrain skin model, the at least one 3D street-level-culture model, and the associated geo-coded content, according to at least one of the user identification, user present-position information and at least one user command to form a perspective view of the real urban environment to be sent to the network terminal.

Even further, according to yet another aspect of the present invention there is provided the computer program product for a network server, additionally operative to interface to an application program, and wherein the application program is operative to identify at least partly the plurality of 3D building models, the terrain skin model, the at least one 3D street-level-culture model, and the associated geo-coded content, according to at least one of the user identification, user present-position information and at least one user command.

Even further, according to still another aspect of the present invention there is provided the computer program product for a network server, wherein the perspective views augmented with associated geo-coded content are determined by the hosted application program.

Unless otherwise defined, all technical and scientific terms used herein have the same meaning as commonly understood by one of ordinary skill in the art to which this invention belongs. The materials, methods, and examples provided herein are illustrative only and not intended to be limiting. Except to the extent necessary or inherent in the processes themselves, no particular order to steps or stages of methods and processes described in this disclosure, including the figures, is intended or implied. In many cases, the order of process steps may vary without changing the purpose or effect of the methods described.

Implementation of the method and system of the present invention involves performing or completing certain selected tasks or steps manually, automatically, or any combination thereof. Moreover, according to actual instrumentation and equipment of preferred embodiments of the method and system of the present invention, several selected steps could be implemented by hardware or by software on any operating system of any firmware or any combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified block diagram of client-server configurations of a large-scale, high-fidelity, three-dimensional visualization system, describing three types of client-server configurations, according to a preferred embodiment of the present invention;

FIG. 2 is a simplified illustration of a plurality of GeoSim cities hosted applications according to a preferred embodiment of the present invention;

FIG. 3 is a simplified functional block diagram of the large-scale, high-fidelity, three-dimensional visualization system according to a preferred embodiment of the present invention;

FIG. 4 is a simplified user interface of a three-dimensional visualization system according to a preferred embodiment of the present invention; and

FIG. 5 is a simplified block diagram of the visualization system according to a preferred embodiment of the present invention.

### DESCRIPTION OF THE PREFERRED EMBODIMENTS

The present embodiments comprise a large-scale, high-fidelity, three-dimensional visualization system and method. The system and the method are particularly useful for three-dimensional visualization of urban environments. The system and the method are further useful to enable an application program to interact with a user via a three-dimensional visualization of an urban environment.

The principles and operation of a large-scale, high-fidelity, three-dimensional visualization system and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments, of being practiced, or carried out in various ways. In addition, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text has the same use and description as in the previous drawings where it was described.

The present invention provides perspective views of an urban area, based on high-fidelity, large-scale 3D digital models of actual urban areas, preferably augmented with additional geo-coded content. In this document, such high-fidelity, large-scale 3D digital models of actual cities and/or urban places (hereafter: “3DMs”) integrated with additional geo-coded content are referred to as “GeoSim cities” (or “GeoSim city”).

A 3DM preferably consists of the following three main data layers:

Building models (“BM”), which are preferably a collection of digital outdoor representations of houses and other man-built structures (“buildings”), preferably by means of a two-part data structure such as side wall/roof-top geometry and side wall/roof-top textures, preferably using RGB colors.

A terrain skin model (“TSM”), which is preferably a collection of digital representations of paved and unpaved terrain skin surfaces, preferably by means of a two part data structure such as surface geometry and surface textures, preferably using RGB colors.

A street-level culture model (“SCM”), which is preferably a collection of digital representations of “standard” urban landscape elements, such as: electric poles, traffic lights, traffic signs, bus stops, benches, etc, trees and vegetation, by means of a two part data structure: object surface geometry and object surface textures, preferably using RGB colors.

The present invention provides web-enabled applications with client-server communication and processing/manipulation of user commands and 2D and 3D data, which preferably consist of:

3DM—referenced to precise, GPS-compatible coordinates; and

Additional content (pertinent to specific applications of GeoSim cities)—referenced to the same coordinate system (“geo-coded”) and linked to the 3DM.

Typically, the additional geo-coded content described above includes the following four main data layers:

Indoor models, which are digital representations of indoor spaces within buildings whose 3D models are contained in the 3DM data. Such digital representations may be based on Ipix technology; (360-degrees panoramas), MentorWave technology (360-degrees panoramas created along pre-determined “walking paths”) or a full 3D-model.

Web pages, which are a collection of text, images, video and audio representing geo-coded engineering data, demographic data, commercial data, cultural data, etc. pertinent to the modeled city.

User ID and Virtual Spatial Location (“IDSL data”):

3DM and additional geo-coded content are protected by proprietary data formats and ID codes.

Authorized users are preferably provided with appropriate user ID keys, which enable them to activate various GeoSim city applications. User ID also preferably provides personal or institutional identification.

Virtual spatial location represents user's current “present position” and “point-of-view” while “navigating” throughout the 3DM.

IDSL data of all concurrent users of GeoSim cities is referred to as “global” IDSL data, and is used to support human interaction between different users of GeoSim cities.

3D-links are spalogical (spatial and logical) links between certain locations and 3D objects within the 3DM and corresponding data described above.

The 3DM and additional geo-coded content are communicated and processed/manipulated in the following three main client-server configurations.

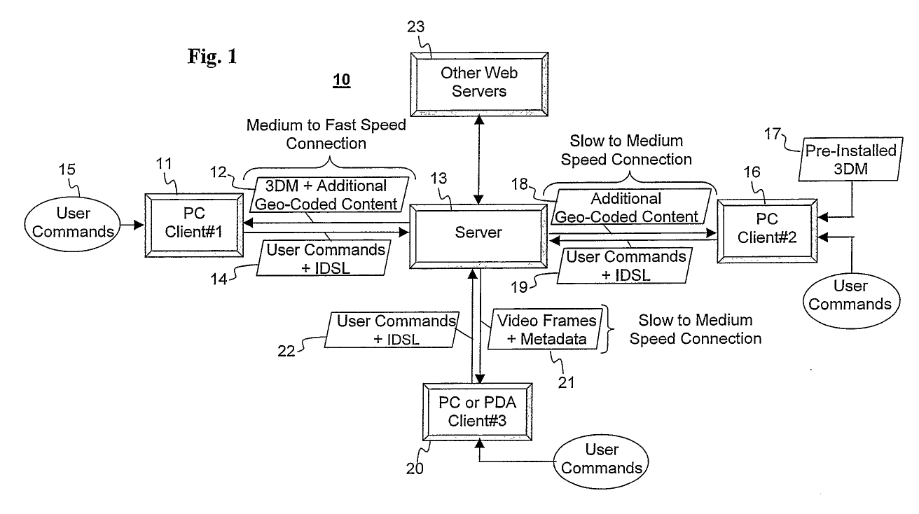

Reference is now made to FIG. 1, which is a simplified block diagram of client-server configurations of a large-scale, high-fidelity, three-dimensional visualization system 10 according to a preferred embodiment of the present invention. FIG. 1 describes three types of client-server configurations.

A client unit 11, also identified as PC Client#1, preferably employs a 3DM streaming configuration. In this configuration the 3DM and additional geo-coded content 12 preferably reside at the server 13 side and are streamed in real-time over the Internet to the client 11 side, responsive to user commands and IDSL 14. The client 11, preferably a PC computer, processes and manipulates the streamed data in real-time as needed to render perspective views of urban terrain augmented with additional geo-coded content. Online navigation through the city model (also referred to as “city browsing”) is preferably accomplished by generating a user-controlled 15 dynamic sequence of such perspective views. This configuration supports two types of Internet connections:

A very fast connection (Mbits/sec), which preferably provides an unconstrained, continuous navigation through the entire city model.

A medium-speed connection (hundreds of kbits/sec), which preferably provides a “localized” continuous navigation within a user-selected segment of the city model.

A client unit 16, also identified as PC Client#2, preferably employs a pre-installed 3DM Configuration 17. In this configuration the 3DM is pre-installed at the client 16 side, preferably in non-volatile memory such as a hard drive, while additional geo-coded content 18 (typically requiring much more frequent updates than the 3DM) preferably resides at the server 13 side and is streamed in real-time over the Internet side, responsive to user commands and IDSL 19. The client 16, preferably a PC computer, processes and manipulates both local and streamed data as needed to generate a user-controlled navigation through the city model. This configuration supports low to medium speed Internet connections allowing an unconstrained, continuous navigation through the entire city model.

A client unit 20, also identified as PC Client#3, preferably employs a video-streaming configuration. In this configuration the 3DM and additional geo-coded content reside at the server 13 side and are processed and manipulated in real-time by the server computer 13 as needed to render perspective views of an urban environment integrated with additional geo-coded content. Such user-controlled perspective views can be generated either as a sequence of still images or as dynamic video clips 21, preferably responsive to user commands and IDSL 22. This configuration preferably supports any kind of Internet connection but is preferably used to viewing on the client 20 side pre-rendered images (e.g. stills and video clips). This solution preferably suites current PDA's and cellular receivers, which lack computing power and memory, needed for real-time 3D image rendering.

The large-scale, high-fidelity, three-dimensional visualization system 10 supports web-enabled applications, preferably provided via other web servers 23. The web-enabled applications of GeoSim cities can be divided into three main application areas:

Professional Applications include urban security, urban planning, design and analysis, city infrastructure, as well as decision-making concerning urban environments.

Business Applications include primarily customer relationship management (CRM), electronic commerce (e-Commerce), localized search and online advertising applications.

Edutainment Applications include local and network computer games, other interactive “attractions”, visual education and learning systems (training and simulation) and human interaction in virtual 3D space.

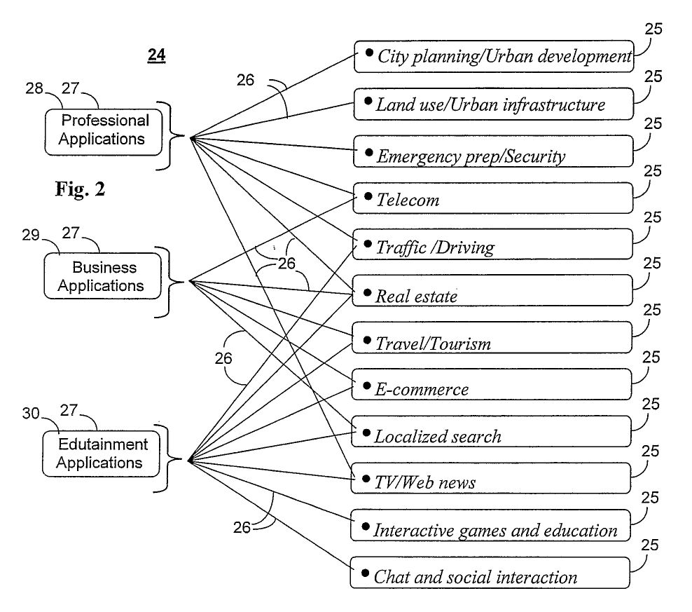

Reference is now made to FIG. 2, which is a simplified illustration of a map 24 of GeoSim cities hosted applications 25 according to a preferred embodiment of the present invention. The GeoSim cities applications of FIG. 2 emphasize the interconnections and interdependencies 26 between the aforementioned main application areas 27.

The gist of the GeoSim city concept is therefore as follows: due to high modeling precision, superior graphic quality and special data structure (amenable for real-time, Web-enabled processing and manipulation), the very same 3D-city model is capable of supporting a wide range of professional, business and edutainment applications, as further presented below.

Professional Applications 28

The main customers and users of the Professional Applications 28 primarily come from the following sectors:

Government (federal, regional, state and local)—urban planners and analysts, urban development and maintenance experts, city/federal managers, law enforcement and military.

Real estate industry—architects and designers, building contractors, real estate developers and agents, real-estate investment banks and institutions.

Telecom industry—cellular, cable, fiber, wireless and optical network planners and analysts.

Media—film, newspaper and publishing art designers and producers.

The main applications of the professional applications 28 are:

City planning and urban development.

Land use and property ownership.

Emergency preparations and security.

Planning, permitting and monitoring of architecture, engineering, construction and telecom projects.

Maintenance and monitoring of urban infrastructure.

Traffic analysis, planning and monitoring.

Event/scene reconstruction.

Typical additional contents pertinent to GeoSim city professional applications 28 comprise of the following types of data:

Layout and inventory of urban infrastructure—electric, gas, communication, cable, water, and waste lines (GIS data).

Land use and property ownership data (parcel maps), including basis and tax particulars.

City development and conservation plans (on macro and micro levels).

Demographic data for commercial and residential real estate.

Disaster management, event planning, security, law enforcement and emergency evacuation plans.

Traffic data and public transportation lines.

Historic and cultural amenities.

To incorporate the above content in various GeoSim city professional applications, the content is preferably geo-coded and linked to corresponding locations and 3D objects within the 3DM.

The following main utilities are preferably provided to properly support GeoSim city professional applications 28:

Client-Server Communication preferably enables dynamic delivery of data residing/generated at the server's side for client-based processing and manipulation, and server-based processing and manipulation of data residing and/or generated at the client's side.

Database Operations preferably enabling object-oriented search of data subsets and search of predefined logic links between such data subsets, as well as integration, superposition and substitution of various data subsets belonging to 3DM and other contents.

3DM Navigation preferably enabling dynamic motion of user's “present position” or POV (“point-of-view”) and LOS (“line-of-sight”) throughout the 3DM. Such 3DM navigation can be carried out in three basic navigation modes:

“Autonomous” mode—“present position” preferably locally controlled by the user.

“Guided tour” mode—“present position” preferably remotely controlled by the server.

“Buddy” mode—“present position” preferably remotely controlled by another user.

IDSL Tracking preferably enabling dynamic tracking of identification and spatial location (IDSL) data of all concurrent users of GeoSim cities.

Image Rendering & 3D Animation preferably enabling 3D visualization of 3DM, additional geo-coded contents and IDSL data; i.e. to generate a series of images (“frames”) representing perspective views of 3DM, additional geo-coded contents and IDSL data as “seen” from the user's POV/LOS, and to visualize 3D animation effects.

Data Paging and Culling preferably enabling dynamic download of minimal subsets of 3DM and additional geo-coded contents needed for efficient (real-time) image rendering.

3D Pointing preferably enabling dynamic finding of LOS “hit points” (i.e. x,y,z—location at which a ray traced from the user's point-of-view along the line-of-sight hits for the first time a “solid surface” belonging to the 3DM or additional geo-coded contents) and identification of the 3D objects on which such hit points are located.

3D Mensuration preferably enabling measuring dimensions of polylines, areas of surfaces, and volumes of 3D objects outlined by a 3D pointing process carried out within the 3DM, and for a line-of-sight analysis.

Business Applications 29

The main customers and users of the business applications 29 are typically business, public and government organizations having an interest in high-fidelity, large-scale 3D city models and their integration with CRM and e-commerce applications are the main customers for GeoSim city-based business applications. The target “audience” (and the main user) for such applications is the general public.

The main applications of the business applications 29 are:

Visualization tool for CRM/e-Commerce applications (primarily online advertising).

Visualization tool for location-based, online directory of Web-listed businesses, organizations and institutions (a so-called “localized search and visualization” application).

Virtual tours and visual guides for the entire city or for special areas/sites of interest.

Virtual souvenirs featuring customized digital photos and voice messages inserted into the city model at locations where these photos/messages were taken/sent.

Geo-referenced tool for virtual polling and rating.

Typical additional contents pertinent to GeoSim city business applications 29 comprise of the following types of data:

Names, postal and email addresses, telephone/fax numbers and descriptions of identity and main activity areas of city-based businesses, organizations and institutions.

Data pertaining to products/services displayed and advertised in GeoSim cities.

Tourism related databases (city landmarks, sites of interest, traffic/parking spaces).

City related communication databases.

CRM/e-Commerce databases.

To incorporate the above content in various GeoSim city business applications, the content is preferably geo-coded and linked to corresponding locations and 3D objects within the 3DM.

The following main utilities are preferably provided to properly support GeoSim city business applications 29:

Client-Server Communication

### Database Operations

3DM Navigation

IDSL Tracking

Image Rendering & 3D Animation

Data Paging and Culling

3D Pointing

3D Animation—to allow for the following types of dynamic 3D animations: Showing virtual billboards and commercial advertisement as dynamic 3D scenes inserted into corresponding perspective views of 3DM and additional geo-coded contents.

Showing “virtual marketers”, “virtual agents” and “virtual guides” as 3D human characters (“avatars”), as well as virtual traffic (pedestrians, automobiles and airborne vehicles) located throughout the 3DM.

Communication—to allow for instant messages, chat, voice or video communication (depending on available communication bandwidth) between the user and commercial agents and business/government representatives.

Unless noted the utilities for the business applications 29 are preferably similar to the same utilities of the professional applications 28.

Edutainment Applications 30

The main customers and users of the edutainment applications 30 come primarily from the following sectors:

Public and to a lesser extent professional users are the main customers for GeoSim city-based edutainment applications.

Edutainment content providers are edutainment professionals coming from the following sectors:

Media and Entertainment—journalists, content developers and producers, graphic and art designers for film, television, computer and video games.

Education—content developers and producers, graphic and art designers, etc.

Government—culture and education experts and employees.

The main applications of the edutainment Applications 30 are:

Interactive, local and network games, contests and lotteries.

Interactive shows and “other events” (educational, cultural, sports and political ones).

Selected Web news, music and video-on-demand.

Virtual tours featuring cultural heritage, historic reconstruction, as well as general sightseeing.

Virtual “rendezvous” and interactive personal communication through instant messages, chat, voice and video.

Training and simulation applications.

Typical additional content pertinent to GeoSim city edutainment applications 30 comprises of the following types of data:

Typical additional contents pertinent to edutainment applications comprise of the following types of data:

Scripts and interaction procedures for interactive games, contests, lotteries and training and simulation exercises.

Scripts and interaction procedures for interactive shows and other “attractions”.

Web news, music, and video-on-demand contents.

City-related cultural heritage and historic reconstruction contents.

Virtual sightseeing paths and accompanying edutainment contents.

To incorporate the above content in various GeoSim city edutainment applications 30, the content is preferably geo-coded and linked to corresponding virtual locations and virtual display areas.

The following main utilities are preferably provided to properly support GeoSim city edutainment applications 30:

Client-Server Communication

Database Operations

3DM Navigation, additionally and preferably enabling the generation of four main navigation modes:

Virtual walk-through—constraining user's “present position” to movement along virtual sidewalks.

Virtual drive-through—constraining user's “present position” to movement along virtual roads.

Virtual hover and fly-through—constraining user's “present position” to aerial movement.

Virtual compete-through—constraining user's “present position” to movement restricted by spatial buffer zone rules of multiple users.

In the above modes of navigation, automated “Collision Avoidance” procedures are preferably activated to prevent “collisions” with 3D-objects and other users moving concurrently in the adjacent virtual space.

IDSL Tracking

Image Rendering & 3D Animation

Data Paging and Culling

3D Pointing

3D Animation—in addition to the features presented in paragraphs 2, 4 and 8 above, this utility enables producing the following animations:

Avatars representing all concurrent users, who “appear” according to their ID and move according to their “present position” (in all possible navigation modes).

Virtual playmates, virtual anchor persons and virtual actors/celebrities participating and guiding edutainment applications.

Facial expressions and lip mouth movements in avatars representing “animated chat”.

User-to-User Communication—to allow for instant messages, chat, voice or video communication, as well as exchange of electronic files and data (depending on available communication bandwidth) between any concurrent users of GeoSim cities.

Unless noted above, the utilities for the edutainment applications 30 are preferably similar to the same utilities of the professional applications 28.

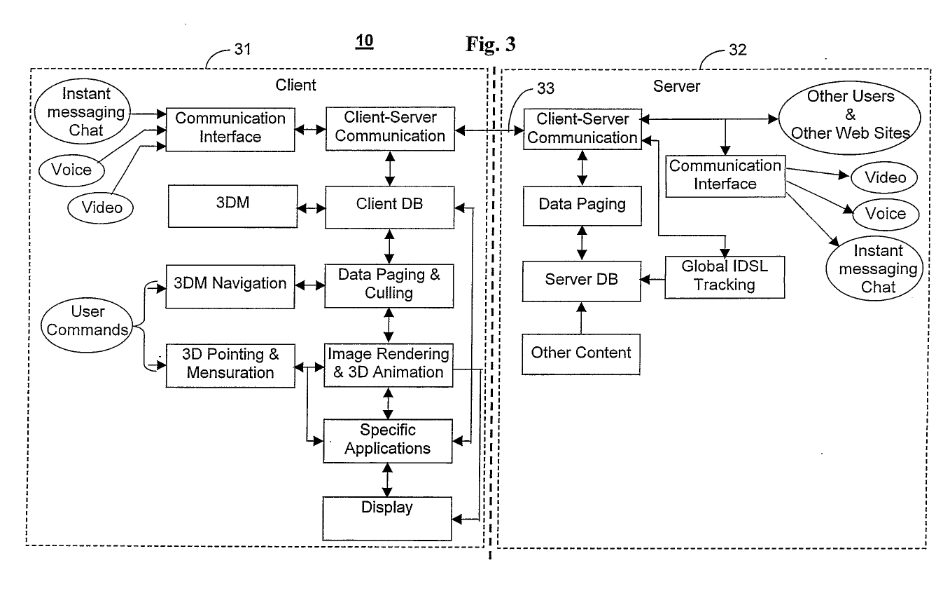

Reference is now made to FIG. 3, which is a simplified functional block diagram of the large-scale, high-fidelity, three-dimensional visualization system 10 according to a preferred embodiment of the present invention.

The three-dimensional visualization system 10 contains a client side 31, preferably a display terminal, and a server 32, interconnected via a connection 33, preferably via a network, preferably via the Internet.

The functional block diagram of the system architecture of FIG. 3 is capable of supporting professional, business and edutainment applications presented above.

Such GeoSim city applications may work either as a stand-alone application or as an ActiveX component embedded in a “master” application. Web-enabled applications can be either embedded into the existing Web browsers or implemented as an independent application activated by a link from within a Web browser.

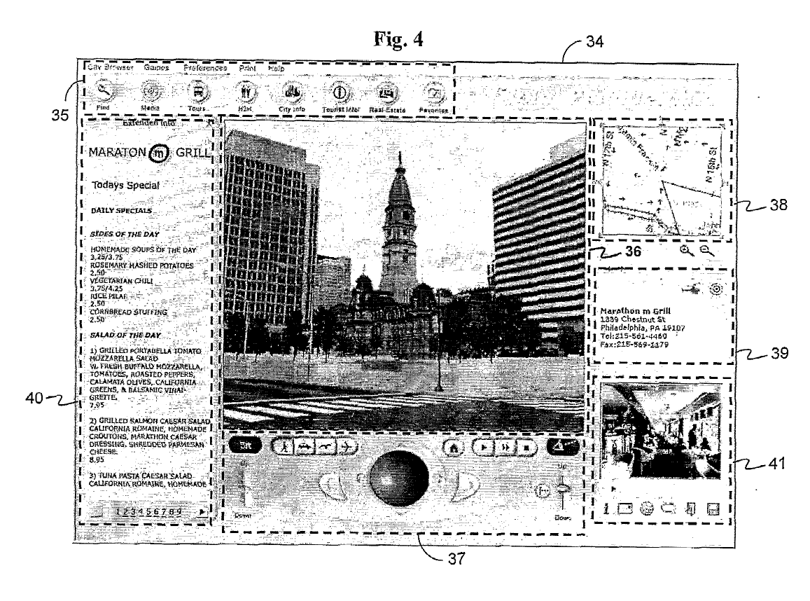

Reference is now made to FIG. 4, which is a simplified user interface 34 of an example of an implementation of the three-dimensional visualization system 10, according to a preferred embodiment of the present invention.

User interface and specific application functions are to be “custom-made” on a case-by-case basis, in compliance with specific needs and requirements of each particular GeoSim city application. FIG. 4 shows the user interface 34 of a preferred Web-enabled application developed by GeoSim also referred to as the CityBrowser, which implements most of the utilities mentioned above.

As shown in FIG. 4, the user interface 34 preferably contains the following components:

an application Toolbar 35;

a 3D Viewer 36;

a Navigation Panel 37;

a 2D Map window 38;

a “Short Info” window 39;

a pull-down “Extended Info” window 40; and

a “Media Center” window 41, preferably for Video Display.

GeoSim cities are therefore in their nature an application platform with certain core features and customization capabilities adaptable to a wide range of specific applications.

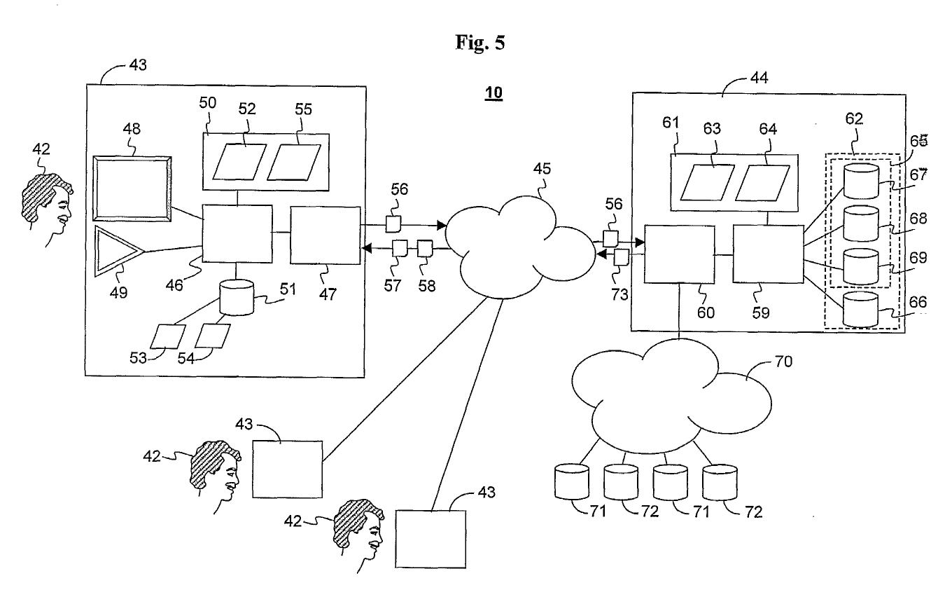

Reference is now made to FIG. 5, which is a simplified block diagram of the visualization system 10 according to a preferred embodiment of the present invention.

As shown in FIG. 5, users 42 preferably use client terminal 43, which are preferably connected to a server 44, preferably via a network 45.

It is appreciated that network 45 can be a personal area network (PAN), a local area network (LAN) a metropolitan area network (MAN) or a wide area network (WAN), or any combination thereof. The PAN, LAN, MAN and WAN can use wired and/or wireless data transmission for any part of the network 45.

Each of the client terminals 43 preferably contains a processor 46, a communication unit 47 a display 48 and a user input device 49. The processor 46 is preferably connected to a memory 50 and to a client storage 51.

The client storage 51 preferably stores client program 52, avatars 53, visual effects 54 and optionally also one or more hosted applications 55, Preferably, at least part of the client program 52, the hosted application 55, the avatars 53 and the visual effects 54 are loaded, or cached, by the processor 46 to the memory 50. Preferably, the processor 46 is able to download parts of the client program 52, the hosted application 55, the avatars 53 and the visual effects 54 from the server 44 via the network 45 to the client storage 51 and/or to the memory 50.

It is appreciated that the visual effects 54 preferably contain static visual effects and/or dynamic visual effects, preferably representing illumination, weather conditions and explosions. It is also appreciated that the avatars 53 contain three-dimensional (3D) static avatars and 3D moving avatars. It is further appreciated that the avatars 53 preferably represent humans, animals, vehicles, etc.

The processor 46 preferably receives user inputs via the user input device 49 and sends user information 56 to the server 44 via the communication unit 47. The user information 56 preferably contains user identification, user present-position information and user commands.

The processor 46 preferably receives from the server 44, via the network 45 and the communication unit 47, high-fidelity, large-scale 3D digital models 57 of actual urban areas, preferably augmented with additional geo-coded content 58, preferably in response to the user commands.

The processor 46 preferably controls the display 48 according to instructions provided by the client program 52, and/or the hosted application 55. The processor 46 preferably creates perspective views of an urban area, based on the high-fidelity, large-scale 3D digital models 57 and the geo-coded content 58. The processor 46 preferably creates and manipulates the perspective views using display control information provided by controls of the avatars 53, the special effects 54 and user commands received form the user input device 49. The processor 46 preferably additionally presents on the display 48 user interface information and geo-coded display information, preferably based on the geo-coded content 58.

As shown in FIG. 5, the server 44 preferably contains a processor 59, a communication unit 60, a memory unit 61, and a storage unit 62. The memory 61 preferably contains server program 63 and optionally also hosted application 64. Preferably the server program 63 and the hosted application 64 can be loaded from the storage 62.

It is appreciated that the large-scale, high-fidelity, three-dimensional visualization system 10 can host one or more applications, either as hosted application 55, hosted within the client terminal 43, or as hosted application 64, hosted within the server 44, or distributed within both the client terminal 43 and the server 44.

Storage unit 62 preferably contains high-fidelity, large-scale 3D digital models (3DM) 65, and the geo-coded content 66.

The 3DM preferably contains:

Building models 67 (“BM”), which are preferably a collection of digital outdoor representations of houses and other man-built structures (“buildings”), preferably by means of a two-part data structure such as side wall/roof-top geometry and side wall/roof-top textures, preferably using RGB colors.

At least one terrain skin model 68 (“TSM”), which is preferably a collection of digital representations terrain surfaces. The terrain skin model 68 preferably uses a two part data structure, such as surface geometry and surface textures, preferably using RGB colors. The terrain skin model 68 preferably contains a plurality of 3D-models, preferably representing unpaved surfaces, roads, ramps, sidewalks, passage ways, stairs, piazzas, traffic separation islands, etc.

At least one street-level culture model 69 (“SCM”), which is preferably a collection of digital representations of “standard” urban landscape elements, such as: electric poles, illumination poles, bus stops, street benches, fences, mailboxes, newspaper boxes, trash cans, fire hydrants, traffic lights, traffic signs, trees and vegetation, etc. The street-level culture model 69 preferably uses a two-part data structure, preferably containing object surface geometry and object surface textures, preferably using RGB colors.

The server 44 is additionally preferably connected, via network 70, to remote sites, preferably containing remote 3DM 71 and or remote geo-coded content 72. It is appreciated that several servers 44 can communicate over the network 70 to provide the required 3DM 65 or 71, and the associated geo-coded content 66 or 72, and/or to enable several users to coordinate collaborative application, such as a multi-player game.

It is appreciated that network 70 can be a personal area network (PAN), a local area network (LAN) a metropolitan area network (MAN) or a wide area network (WAN), or any combination thereof. The PAN, LAN, MAN and WAN can use wired and/or wireless data transmission for any part of the network 70.

It is appreciated that the geo-coded content 66 and 72 preferably contains information organized and formatted as Web pages. It is also appreciated that the geo-coded content 66 and 72 preferably contains text, image, audio, and video.

The processor 59 preferably processes the high-fidelity, large-scale, three-dimensional (3D) model 65, and preferably but optionally the associated geo-coded content 66. Typically and preferably the processor 59 preferably processes the 3D building models, the terrain skin model, and the street-level-culture model and the associated geo-coded content 66 according to the user present-position, the user identification information, and the user commands as provided by the client terminal 43 within the user information 56. The processor 59 preferably performs the above-mentioned processing according to instructions provided by the server program 63 and optionally also by the hosted application 64.

It is appreciated that the server program 63 preferably interfaces to the application program 64 to enable the application program 64 to identify at least partly, any of the 3D building models, the terrain skin model, the 3D street-level-culture model, and the associated geo-coded content, preferably according to the user identification, and/or the user present-position information, and/or the user command.

The processor 59 preferably communicates the processed information 73 to the terminal device 43, preferably in the form of the high-fidelity, large-scale 3D digital models 57 and the geo-coded content 58. Alternatively, the processor 59 preferably communicates the processed information in the form of rendered perspective views.

Preferably, the processor 46 of the terminal device 43 performs rendering of the perspective views of the real urban environments and their associated geo-coded content to form an image on the display 48 of the terminal device 43.

Alternatively, the processor 59 of the server 44 performs rendering of the perspective views of the real urban environments and their associated geo-coded content to form an image, and sends this image via the communication unit 60, the network 45 and the communication unit 47 to the processor 46 to be displayed on the display 48 of the terminal device 43.

Further alternatively, some of the perspective views are rendered at the server 44, which communicates the rendered images to the terminal device 43, and some of the perspective views are rendered by the terminal device 43.

Preferably, the rendering additionally contains:

rendering the perspective views by the server 44 when the 3D model and the associated geo-coded content has not been received by the terminal device;

rendering the perspective views by the server 44 when the terminal device 43 does not have the image rendering capabilities; and

rendering the perspective views by the terminal device 43 if the information pertinent to the 3D model and associated geo-coded content have been received by the terminal device 43 and the terminal device 43 has the image rendering capabilities.

It is appreciated that the appropriate split of processing and rendering of the 3D model and the associated geo-coded content, the appropriate split of storage of the 3D model and the associated geo-coded content, visual effects, avatars, etc. as well as the appropriate distribution of the client program 52, the client hosted application 55, the server program 63 and the server hosted application 64 (whether in hard drives or in memory) enable the use of a variety of terminal devices, such as thin clients having limited resources and thick clients having high processing power and large storage capacity. The appropriate split and distributions of processing and storage resources is also useful to accommodate limited or highly varying communication bandwidth.

It is appreciated that the rendering of the perspective views preferably corresponds to:

a point-of-view controlled by the user 42 of the terminal device 43; and

a line-of-sight controlled by the user 42 of the terminal device 43.

It is appreciated that the point-of-view and/or the line-of-sight are preferably limited by one or more predefined rules. Preferably the rules limits the rendering so as to:

avoid collisions with the building model, terrain skin model and street-level culture model but otherwise representing a “free motion” on the ground or in the air (hovering mode); and

represent a user 42 moving within the displayed perspective view in any of the following modes:

a street-level walk (walking mode);

a road-bound drive (driving mode);

a straight-and-level flight (flying mode); and

externally restricted buffer zones (compete-through mode), preferably restricted by a program, such as a game program, or by another user (player).

It is also appreciated that the rendering and/or the rules preferably additionally contain:

controlling at least one of the point-of-view and the line-of-sight by the server (“guided tour”); and

controlling at least one of the point-of-view and the line-of-sight by a user of another terminal device (“buddy mode” navigation).

It is also appreciated that the information provided to the user 42 on the display 48 of the terminal device 43, and particularly the perspective views of the real urban environment, additionally enable the user 42 to perform the following activities:

search for a specific location within the 3D-model;

search for a specific geo-coded content;

measure distances between two points of the 3D-model;

measure surface area of an element of the 3D-model;

measure volume of an element of the 3D-model; and

interact with a user of another the terminal devices.

It is appreciated that the rendering of the perspective views is preferably executed in real-time.

It is expected that during the life of this patent many relevant large-scale, high-fidelity, three-dimensional visualization systems will be developed and the scope of the terms herein, particularly of the terms “three dimensional model”, “building models”, “terrain skin model”, “street-level culture model”, and “geo-coded content”, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A method for presenting a perspective view of a real urban environment, said perspective view augmented with associated geo-coded content, said perspective view presented on a display of a terminal device, said method comprising:
a) connecting said terminal device to a server via a network;
b) communicating user identification, user present-position information and at least one user command, from said terminal device to said server;
c) processing a high-fidelity, large-scale, three-dimensional (3D) model of an urban environment, and associated geo-coded content by said server, said 3D model comprising data layers as follows:
1) a plurality of 3D building models;
2) a terrain skin model; and
3) at least one 3D street-level-culture model;
d) communicating said 3D model and associated geo-coded content from said server to said terminal device, and
e) processing said data layers and said associated geo-coded content, in said terminal device to form a perspective view of said real urban environment augmented with said associated geo-coded content,
wherein at least one of said data layers and said associated geo-coded content correspond to at least one said user present-position, said user identification information, and said user command.

2. A method according to claim 1 wherein at least one of said data layers additionally comprises at least one of:
1) a 3D avatar representing at least one of a human, an animal and a vehicle; and
2) a visual effect.

3. A method according to claim 1 wherein said terrain skin model comprises a plurality of 3D-models representing at least one of: unpaved surfaces, roads, ramps, sidewalks, passage ways, stairs, piazzas, traffic separation islands.

4. A method according to claim 1 wherein said 3D street-level-culture model comprises a at least one 3D-model representing at least one item of a list comprising: a traffic lights, a traffic sign, an illumination pole, a bus stop, a street bench, a fence, a mailbox, a newspaper box, a trash can, a fire hydrant, and a vegetation item.

5. A method according to claim 1 wherein said geo-coded content comprises information organized and formatted as at least one Web page.

6. A method according to claim 5 wherein said information organized and formatted as at least one Web page comprises at least one of: text, image, audio, and video.

7. A method according to claim 5 wherein said visual effect comprise a plurality of static visual effects and dynamic visual effects.

8. A method according to claim 5 wherein said visual effects comprise a plurality of visual effects representing at least one of: illumination, weather conditions and explosions.

9. A method according to claim 5 wherein said avatars comprise a plurality of 3D static avatars and 3D moving avatars.

10. A method according to claim 1 additionally comprising:
f) rendering perspective views of a real urban environment and augmenting them with associated geo-coded content to form an image on a display of a terminal device.

11. A method according to claim 10 wherein said rendering additionally comprises at least one of:
i) rendering said perspective view by said terminal device;
ii) rendering said perspective view by said server and communicating said rendered perspective view to said terminal device; and
iii) rendering some of said perspective views by said server, communicating them to said terminal device, and rendering other said perspective views by said terminal device.

12. A method according to claim 10 wherein said rendering additionally comprises at least one of:
iv) rendering said perspective views by said server when at least a part of said 3D model and said associated geo-coded content has not been received by said terminal device;
v) rendering said perspective views by said server when said terminal device does not have said image rendering capabilities; and
vi) rendering said perspective views by said terminal device if the information pertinent to said 3D model and associated geo-coded content have been received by said terminal device and said terminal device has said image rendering capabilities.

13. A method according to claim 10 wherein said rendering of said perspective view is executed in real-time.

14. A method according to claim 10 wherein said rendering of said perspective view corresponds to at least one of:
vii) a point-of-view controlled by a user of said terminal device; and
viii) a line-of-sight controlled by a user of said terminal device.

15. A method according to claim 10 wherein at least one of said point-of-view and said line-of-sight being constrained by a predefined rule.

16. A method according to claim 15 wherein said rule comprises at least one of:
1) avoiding collisions with said building model, terrain skin model and street-level culture model (hovering mode); and
2) representing a user moving in at least one of:
a) a street-level walk (walking mode);
b) a road-bound drive (driving mode);
c) a straight-and-level flight (flying mode); and
d) an externally restricted buffer zones (compete-through mode).

17. A method according to claim 14 wherein said rendering additionally comprises at least one of:
1) controlling at least one of said point-of-view and said line-of-sight by said server (“guided tour”); and
2) controlling at least one of said point-of-view and said line-of-sight by a user of another terminal device (“buddy mode” navigation).

18. A method according to claim 1 wherein said perspective view of said real urban environment additionally comprises:
g) enabling a user of said terminal devices to perform at least one of:
1) search for a specific location within said 3D-model;
2) search for a specific geo-coded content;
3) measure at least one of a distance, a surface area, and a volume within said 3D-model; and
4) interact with a user of another said terminal devices.

19. A method for hosting an application program within a terminal device, said method comprising:
a) connecting said terminal device to a server via a network;
b) communicating user identification, user present-position information and said user command, from said terminal device to said server;
c) communicating a high-fidelity, large-scale, three-dimensional (3D) model of an urban environment, and associated geo-coded content, from said server to said terminal device, said 3D model comprising data layers as follows:
1) a plurality of 3D building models;
2) a terrain skin model; and
3) a plurality of 3D street-level-culture models; and
d) processing said data layers and said associated geo-coded content to form a perspective view of said real urban environment augmented with associated geo-coded content;
wherein at least one of said perspective views corresponds to at least one of: said user present-position, said user identification information, and said user command, and
wherein at least one of said perspective views augmented with associated geo-coded content is determined by said hosted application program.

20. A display terminal operative to provide perspective views of a real urban environment augmented with associated geo-coded content on a said display terminal comprising:
a) a communication unit connecting said terminal device to a server via a network, said communication unit operative to:
1) send to said server at least one of: user identification, user present-position information and at least one user command; and
2) receive from said server a high-fidelity, large-scale, three-dimensional (3D) model of an urban environment, and associated geo-coded content, said 3D model comprising data layers as follows:
i) a plurality if 3D building models;
ii) a terrain skin model; and
iii) a plurality of 3D street-level-culture models; and
b) a processing unit operative to process said data layers and said associated geo-coded content, as to form perspective views of said real urban environment augmented with associated geo-coded content on a display of said display terminal;
wherein said perspective view corresponds to at least one of: said user present-position, said user identification information, and said user command.

21. A display terminal according to claim 20 wherein said network is one of:
personal area network (PAN), local area network (LAN), metropolitan area network (MAN), wide area network (WAN), wired data transmission, wireless data transmission, and combinations thereof.

22. A display terminal according to claim 20 additionally operative to host an application program and wherein said combined perspective view is at least partially determined by said hosted application program.

23. A network server operative to communicate perspective views of a real urban environment augmented with associated geo-coded content to a display terminal, said network server comprising:
a) a communication unit connecting said server to at least one terminal device via a network, said communication unit operative to:
1) receive from said terminal device user identification, user present-position information and at least one user command; and
2) send to said terminal device a high-fidelity, large-scale, three-dimensional (3D) model of an urban environment, and associated geo-coded content, said 3D model comprising data layers as follows:
i) a plurality if 3D building models;
ii) a terrain skin model; and
iii) a plurality of 3D street-level-culture models; and
b) a processing unit operative to process said data layers and said associated geo-coded content to form a perspective view of said real urban environment augmented with associated geo-coded content;
wherein said perspective view corresponds to at least one of: said user present-position, said user identification information, and said user command.

24. A network server according to claim 23 wherein said network is one of: personal area network (PAN), local area network (LAN), metropolitan area network (MAN), wide area network (WAN), wired data transmission, wireless data transmission, and combinations thereof.

25. A network server according to claim 23 additionally comprising:
a memory unit operative to host an application program;
and wherein said processing unit is operative to form at least one of said perspective views according to instructions provided by said application programs.

26. A computer program product, stored on one or more computer-readable media, comprising instructions operative to cause a programmable processor of a network device to:
a) connect said terminal device to a server via a network;
b) communicate user identification, user present-position information and at least one user command, from said terminal device to said server;
c) communicate a high-fidelity, large-scale, three-dimensional (3D) model of an urban environment, and associated geo-coded content, from said server to said terminal device, said 3D model comprising of data layers as follows:
1) a plurality if 3D building models;
2) a terrain skin model; and
3) a plurality of 3D street-level-culture models; and
d) process said data layers and said associated geo-coded content to form a perspective view of said real urban environment augmented with associated geo-coded content;
wherein at least one of said perspective view corresponds to at least one of: said user present-position, said user identification information, and said user command.

27. A computer program product according to claim 26 wherein said network is one of: personal area network (PAN), local area network (LAN), metropolitan area network (MAN), wide area network (WAN), wired data transmission, wireless data transmission, and combinations thereof.

28. A computer program product according to claim 26 additionally operative to interface to an application program, and wherein said application program is operative to determine at least partly said plurality of 3D building models, said terrain skin model, said at least one 3D street-level-culture model, and said associated geo-coded content, according to at least one of said user identification, user present-position information and at least one user command.

29. A computer program product according to claim 28 wherein said perspective views augmented with associated geo-coded content are determined by said hosted application program.

30. A computer program product, stored on one or more computer-readable media, comprising instructions operative to cause a programmable processor of a network server to:
a) receive user identification, user present-position information and at least one user command from at least one network terminal via a network;
b) send to said network terminal a high-fidelity, large-scale, three-dimensional (3D) model of an urban environment, and associated geo-coded content, said 3D model comprising of data layers as follows:
1) a plurality if 3D building models;
2) a terrain skin model; and
3) a plurality of 3D street-level-culture models; and
wherein said data layers and said associated geo-coded content pertain to at least one of said user identification, said user present-position information and said user command.

31. A computer program product according to claim 30 wherein said network is one of: personal area network (PAN), local area network (LAN), metropolitan area network (MAN), wide area network (WAN), wired data transmission, wireless data transmission, and combinations thereof.

32. A computer program product according to claim 30 additionally operative to combine said plurality of 3D building models, said terrain skin model, said at least one 3D street-level-culture model, and said associated geo-coded content, according to at least one of said user identification, user present-position information and at least one user command to form a perspective view of said real urban environment to be sent to said network terminal.

33. A computer program product according to claim 30 additionally operative to interface to an application program, and wherein said application program is operative to identify at least partly said plurality of 3D building models, said terrain skin model, said at least one 3D street-level-culture model, and said associated geo-coded content, according to at least one of said user identification, user present-position information and at least one user command.

34. A computer program product according to claim 33 wherein said perspective views augmented with associated geo-coded content are determined by said hosted application program.
